(19) United States
(12) Patent Application Publication
(10) Pub. No.: US 2024/0405525 A1
(43) Pub. Date: Dec. 5, 2024

(54) APPARATUS AND METHOD FOR ROBOTICALLY ROUTING AND SECURING WIRING HARNESS BRANCHES

(71) Applicant: Aptiv Technologies Limited, St. Michael (BB)

(72) Inventors: Nathan UZARSKI, Warren, OH (US); Robert DEAN, New Castle, PA (US); Joseph SUDIK, JR., Niles, OH (US); David PETERSON, Aurora, OH (US)

(21) Appl. No.: 18/204,723

(22) Filed: Jun. 1, 2023

(51) Int. Cl. H02G 1/06; B25J 11/00; B60R 16/02; H02G 3/32

(52) U.S. Cl. CPC H02G 1/06; B25J 11/005; B60R 16/0215; H02G 3/32

(57) ABSTRACT

A method of installing an electrical wiring harness in a vehicle, wherein the electrical wiring harness has at least one branch circuit terminated by an electrical connector includes the steps of wrapping the at least one branch circuit around a wire spool configured to be picked up and manipulated by a robotic arm having a gripping mechanism, placing the electrical wiring harness within the vehicle; and grasping the wire spool with the gripping mechanism while simultaneously moving the robotic arm and rotating the wire spool with the gripping mechanism to pay out a desired length of the at least one branch circuit. An apparatus for performing this method and an electrical wiring harness well suited for use with this method is also described herein.

### FIELD OF THE INVENTION

This patent application is directed to an apparatus and a method for robotically routing and securing wiring harness branches.

### BACKGROUND

After automotive wiring harnesses are assembled, they are shipped to a vehicle assembly plant where they are manually placed and routed through the body of the vehicle. The process of unraveling, routing, and fixing the wiring harness to the vehicle structure is typically performed by human assembly operators in a labor intensive process that requires strategically designed wiring channels and specified routing paths to the corresponding electrical connectors. These wiring channels and routing paths depend on the vehicle model and optional electronic content. The wiring harness routing process in vehicle assembly plants can cause ergonomic issues for the human assembly operators which may cause additional costs for redesigning the wiring harness, adding more components, and complicating the vehicle assembly process complexity to address the ergonomic issues. Often, additional components such as non-standard wiring channels require an expensive and complex design process to create new wiring channel designs.

### SUMMARY

According to one or more aspects of the present disclosure, a method of installing an electrical wiring harness in a vehicle, wherein the electrical wiring harness has at least one branch circuit terminated by an electrical connector, including the steps of:
wrapping the at least one branch circuit around a wire spool configured to be picked up and manipulated by a robotic arm having a gripping mechanism;
placing the electrical wiring harness within the vehicle; and
grasping the wire spool with the gripping mechanism while simultaneously moving the robotic arm and rotating the wire spool with the gripping mechanism to pay out a desired length of the at least one branch circuit.

In some aspects of the method described in the previous paragraph, the method further includes the step of connecting the electrical connector of the at least one branch circuit to a corresponding electrical connector in the vehicle using the gripping mechanism.

In some aspects of the method described in any one of the previous paragraphs, the method further includes the step of calculating a length of the at least one branch circuit payed out from the wire spool based on a diameter of the wire spool, a number of rotations of the wire spool by the gripping mechanism, and a diameter of the at least one branch circuit.

In some aspects of the method described in any one of the previous paragraphs, the method further includes the steps of:
applying an attachment device around the at least one branch circuit using an attachment mechanism connected to the robotic arm; and
securing the attachment device to an attachment feature in the vehicle using the robotic arm.

In some aspects of the method described in any one of the previous paragraphs, the attachment device is a P-clamp that is folded around the at least one branch circuit and wherein the attachment feature is a stud projecting from a panel of the vehicle and inserted within a pair of aligned apertures in the P-clamp.

In some aspects of the method described in any one of the previous paragraphs, the stud is threaded and wherein the P-clamp is secured to the stud by a threaded nut.

In some aspects of the method described in any one of the previous paragraphs, the stud is in a compressive fit with aligned apertures in the P-clamp.

In some aspects of the method described in any one of the previous paragraphs, the attachment device is an annular disk having a plurality of teeth extending from an outer edge of the annular disk and a central aperture in which the at least one branch circuit is received. The attachment feature is a slit in a panel of the vehicle and wherein the annular disk is in a compressive fit within the slit.

In some aspects of the method described in any one of the previous paragraphs, the attachment device is a fir tree fastener that is folded around the at least one branch circuit and wherein the attachment feature is an aperture in a panel of the vehicle in which the fir tree fastener is inserted.

In some aspects of the method described in any one of the previous paragraphs, the fir tree fastener includes a pair of semi-cylindrical mounting studs joined by a strap therebetween. The pair of semi-cylindrical studs defines a plurality of protrusions extending therefrom. The strap is folded around the at least one branch circuit and the semi-cylindrical mounting studs are brought together to form a cylindrical mounting stud defining the plurality of protrusions extending therefrom.

In some aspects of the method described in any one of the previous paragraphs, the plurality of protrusions are a plurality of semi-circular ribs and wherein the plurality of semi-circular ribs are brought together to form a plurality of circular ribs extending from the cylindrical mounting stud.

In some aspects of the method described in any one of the previous paragraphs, the method further includes the steps of packaging the wiring harness at least partially in a channel and placing the channel and the wiring harness in the vehicle.

In some aspects of the method described in any one of the previous paragraphs, the method further includes the step of removing the wire spool and the at least one branch circuit from the channel.

According to one or more aspects of the present disclosure, an apparatus configured to install an electrical wiring harness having at least one branch circuit terminated by an electrical connector in a vehicle includes a robotic arm having a gripping mechanism configured to pick up and manipulate a wire spool having the at least one branch circuit wrapped around it. The gripping mechanism is further configured to rotate the wire spool while the robotic arm is moving along a predetermined path to pay out a desired length of the at least one branch circuit and route the at least one branch circuit in the vehicle. The apparatus also includes an electronic controller configured to control actions of the gripping mechanism and the robotic arm.

In some aspects of the apparatus described in the previous paragraph, the robotic arm and the gripping mechanism are further configured to connect the electrical connector of the at least one branch circuit to a corresponding electrical connector in the vehicle under the control of the electronic controller.

In some aspects of the apparatus described in any of the previous paragraphs, the electronic controller is configured to calculate a length of the at least one branch circuit payed out from the wire spool based on a diameter of the wire spool, a number of rotations of the wire spool by the gripping mechanism, and a diameter of the at least one branch circuit.

In some aspects of the apparatus described in any of the previous paragraphs, the apparatus further includes an attachment mechanism connected to the robotic arm and configured to apply an attachment device around the at least one branch circuit at a predetermined point on the at least one branch circuit based on the calculated length of the at least one branch circuit.

According to one or more aspects of the present disclosure, an electrical wiring harness configured to use in a vehicle including at least one branch circuit terminated by an electrical connector and an attachment device placed around the at least one branch circuit at a predetermined point. The attachment device is selected from a list consisting of:
an annular disk having a plurality of teeth extending from an outer edge of the annular disk and a central aperture in which the at least one branch circuit, the annular disk configured to be received and in a compressive fit within a slit in a panel of the vehicle; and
a fir tree fastener that is folded around the at least one branch circuit and configured to be inserted in an aperture in a panel of the vehicle.

In some aspects of the electrical wiring harness described in the previous paragraph, the fir tree fastener includes a pair of semi-cylindrical mounting studs joined by a strap therebetween. The pair of semi-cylindrical studs defines a plurality of protrusions extending therefrom. The strap is folded around the at least one branch circuit and the semi-cylindrical mounting studs are brought together to form a cylindrical mounting stud defining the plurality of protrusions extending therefrom.

In some aspects of the electrical wiring harness described in the previous paragraph, the plurality of protrusions is a plurality of semi-circular ribs. The plurality of semi-circular ribs are brought together to form a plurality of circular ribs extending from the cylindrical mounting stud.

### DESCRIPTION OF THE DRAWINGS

The present invention is described, by way of example with reference to the accompanying drawing, in which:

FIGS. 1-3 are isometric views of an apparatus configured to install an electrical wiring harness having at least one branch circuit terminated by an electrical connector in a vehicle in various stages on employment according to some embodiments;

FIG. 4 is an isometric view of an attachment device for securing the branch circuit to an attachment feature in the vehicle according to some embodiments;

FIG. 5 is an isometric view of an attachment mechanism of the apparatus of FIG. 1 which is configured to apply the attachment device of FIG. 4 to the branch circuit according to some embodiments;

FIG. 6 is an isometric view of an alternative attachment device securing the branch circuit to an attachment feature in the vehicle according to some embodiments;

FIG. 7 is an isometric view of an attachment mechanism of the apparatus of FIG. 1 which is configured to apply the attachment device of FIG. 6 to the branch circuit according to some embodiments;

FIG. 8 is an isometric view of yet another alternative attachment device securing the branch circuit to an attachment feature in the vehicle according to some embodiments;

FIG. 9 is a flowchart of a method of installing an electrical wiring harness having at least one branch circuit terminated by an electrical connector in a vehicle.

### DETAILED DESCRIPTION

Automating the process of automotive wiring harness installation provides reduced labor cost, minimized quality issues, and mitigated ergonomic concerns that result from manual installation of automotive wiring harness. Automating wiring harness installation reduces installation cycle time and standardize the methods in the wiring harness are routed and secured in the vehicle.

The apparatus and method described herein automates several wiring harness installation functions that are traditionally done manually by human assembly operators in vehicle assembly plants.

As shown in FIG. 1, the wiring harness 100 is packaged at least partially in one or more housings or channels 102 and mounted in the vehicle (not shown). The wiring harness 100 and one or more channels 102 may be mounted in the vehicle manually by a human assembly operator or automatically by an assembly robot. One or more branch circuits 104 of the wiring harness 100 are then routed to their corresponding electrical connectors (not shown) in the vehicle and the branch circuits 104 are secured to the vehicle's structure.

The one or more branch circuits 104 are wrapped around wire spools 106 that are held by the channel 102 during assembly of the wiring harness 100 and channel 102 into the vehicle. The wire spool 106 has a tab 108 that can be grasped and manipulated by a gripping mechanism 110 of a robotic arm 112 to pick up the wire spool 106 thereby removing the wire spool 106 and branch circuit 104 from the channel 102. The robotic arm 112 and the gripping mechanism 110 are controlled by one or more electronic controllers 114. The electronic controllers 114 have one or more processors and memory. The processors may be microprocessors, application specific integrated circuits (ASIC), or built from discrete logic and timing circuits (not shown). Software instructions that program the processors may be stored in a non-volatile memory device (not shown). The memory device may be contained within the microprocessor or ASIC. Alternatively, the memory device may be a separate device. Non-limiting examples of the types of memory device that may be used include electrically erasable programmable read only memory (EEPROM), masked read only memory (ROM), flash memory, and solid state memory devices.

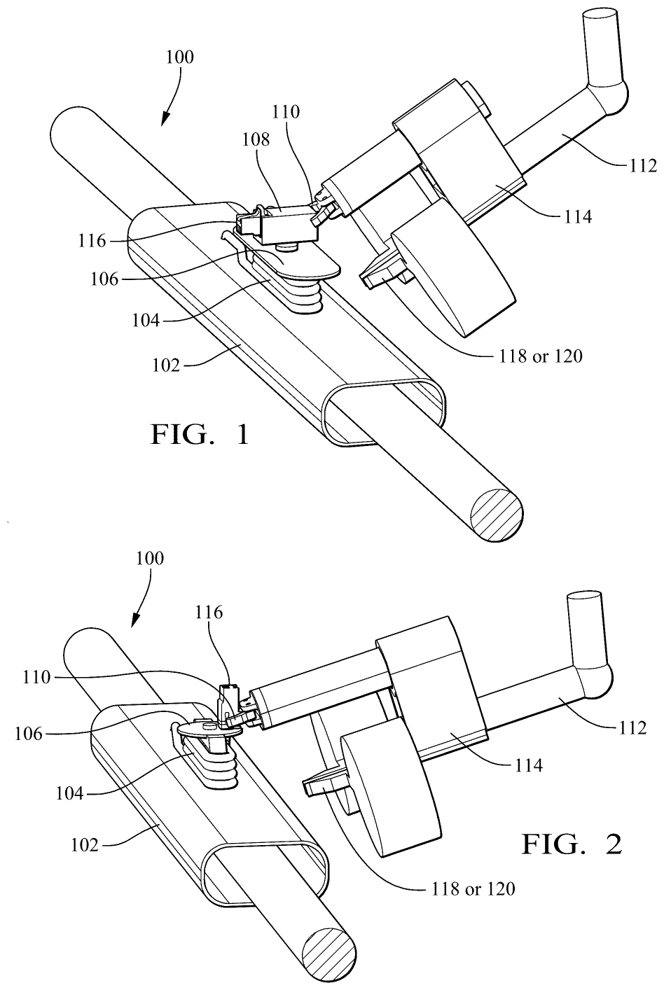

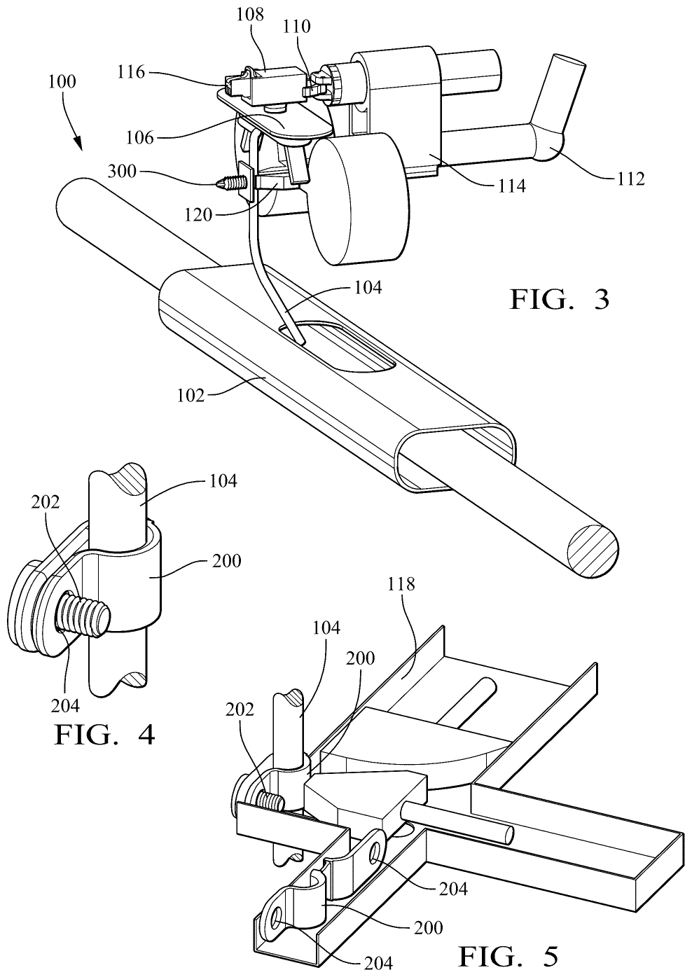

After the wiring harness 100 contained within its channel 102 is placed in the vehicle, the gripping mechanism 110 picks up the wire spool 106 as shown in FIG. 2. The gripping mechanism 110 is further configured to rotate the wire spool 106, thereby unfurling or “paying out” the branch circuit 104 as the robotic arm 112 moves to route the branch circuit 104 within the vehicle as shown in FIG. 3. The length of the branch circuit 104 that has been payed out from the wire spool 106 can be calculated by the electronic controller based on the diameter of the wire spool 106, the number of rotations of the wire spool 106 performed by the gripping mechanism 110, and the diameter of the branch circuit 104. Once the branch circuit 104 has been properly routed in the vehicle, the gripping mechanism 110 can plug the electrical connector 116 at the end of the branch circuit 104 into the corresponding electrical connector (not shown) in the vehicle.

As the robotic arm 112 routes the branch circuit 104 and before plugging the connector(s) 116 of the branch circuit 104, the robotic arm 112 may affix the branch circuit 104 to the vehicle structure using various attachment devices 200, 300, 400 shown in FIGS. 4-8. The robotic arm 112 positions itself to the location in which to secure the branch circuit 104. Then, an attachment mechanism 118 on the robotic arm places the attachment device 200, 300, 400 around the branch circuit 104 and secures the attachment device 200, 300, 400 to the vehicle structure.

Different non-limiting examples of the attachment features are shown in FIGS. 4-8. FIG. 4 shows an example of an attachment device in the form of a P-clamp 200 that is folded around the branch circuit 104. The vehicle defines a corresponding attachment feature for the P-clamp 200 in the form of a stud 202 projecting from a panel of the vehicle. The stud 202 is inserted within a pair of aligned apertures 204 in the P-clamp 200. The stud 202 may be threaded, and the P-clamp 200 may be secured to the stud 202 by a threaded nut (not shown). Alternatively, the stud 202 and aligned apertures 204 may be sized so that the stud 202 is in a compressive fit within the aligned apertures 204 in the P-clamp 200. An example of an attachment mechanism 118 on the robotic arm 112 configured to apply the P-clamp 200 on the branch circuit 104 and secure the P-clamp 200 to the stud 202 on the vehicle structure is shown in FIG. 5.

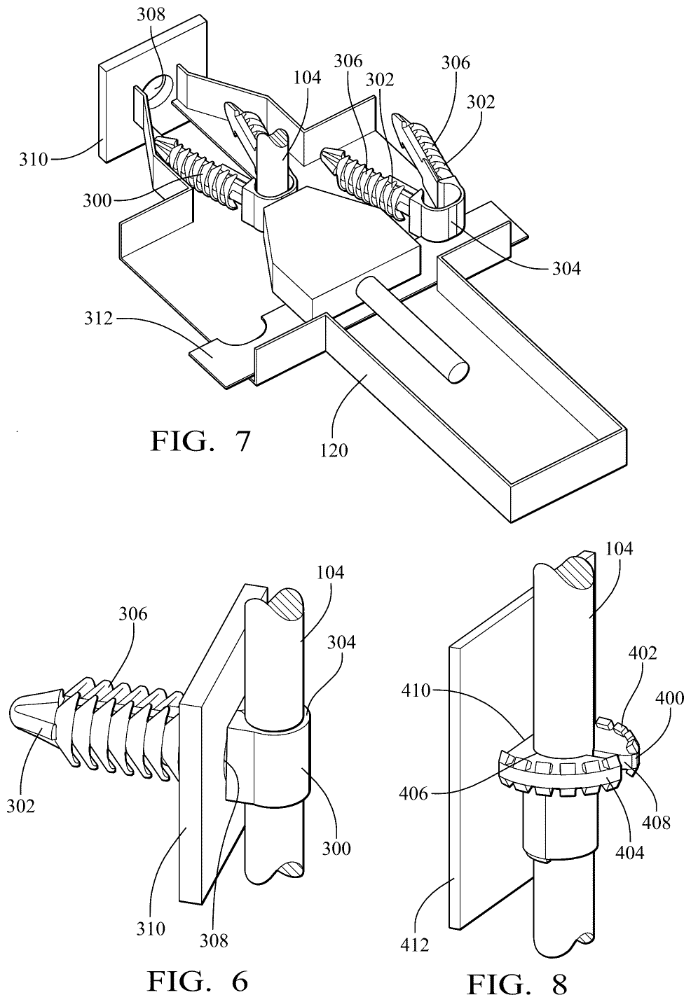

Another example of an attachment feature is shown in FIG. 6. The attachment device is a split fir tree fastener 300 that is folded around the branch circuit 104. The fir tree fastener 300 includes a pair of semi-cylindrical mounting studs 302 joined by a strap 304 therebetween. The pair of semi-cylindrical studs 302 defines a plurality of protrusions 306 extending therefrom. As the strap 304 is folded around the branch circuit 104, the semi-cylindrical mounting studs 302 are brought together to form a cylindrical mounting stud which defies the plurality of protrusions 306 extending that extend from the mounting stud 302. In the example illustrated by FIG. 6, the plurality of protrusions 306 is a plurality of semi-circular ribs. The plurality of semi-circular ribs are brought together to form a plurality of circular ribs extending from the cylindrical mounting stud 302. Alternately, the plurality of protrusions may be one of the many other types of protrusions commonly used with fir tree-type fasteners. The mounting stud 302 is then inserted into a hole or an aperture 308 in a panel 310 of the vehicle in which the split fir tree fastener 300 is inserted to secure the branch circuit 104 to the vehicle structure. An example of an attachment mechanism 120 on the robotic arm 112 configured to apply the split fir tree fastener 300 on the branch circuit 104 and secure the split fir tree fastener 300 to the vehicle structure by inserting the mounting stud 302 in the aperture 308 is shown in FIG. 7. The split fir tree fastener 300 may be detached from a feed strip 312 by the attachment mechanism 120.

FIG. 8 shows yet another example of an attachment feature in the form of a split annular disk 400 that has a plurality of teeth 402 extending from an outer edge 404 of the disk 400. The branch circuit 104 is received in a central aperture 406 in the disk 400 through a channel 408 extending from the outer edge 404 to the central aperture 406. The disk 400 is configured to be inserted into a slit 410, i.e., a rectangular or oblong aperture, in a panel 412 of the vehicle. The annular disk 400 and slit 410 are sized so that the plurality of teeth 402 engage edges of the slit 410 and/or the disk 400 is in a compressive fit within the slit 410.

One or more of the attachment devices 200, 300, 400 described above may be used to secure the branch circuit 104 to the vehicle structure. Alternatively, other types of attachment features may also be employed.

After the channel 102 is mounted within the vehicle, the routing of the branch circuit 104 is completed, and the gripping mechanism 110 has plugged the connector 116 into the corresponding electrical connector in the vehicle, the gripping mechanism 110 releases the electrical connector 116 and removes the wire spool 106 that was used to coil the branch circuit 104.

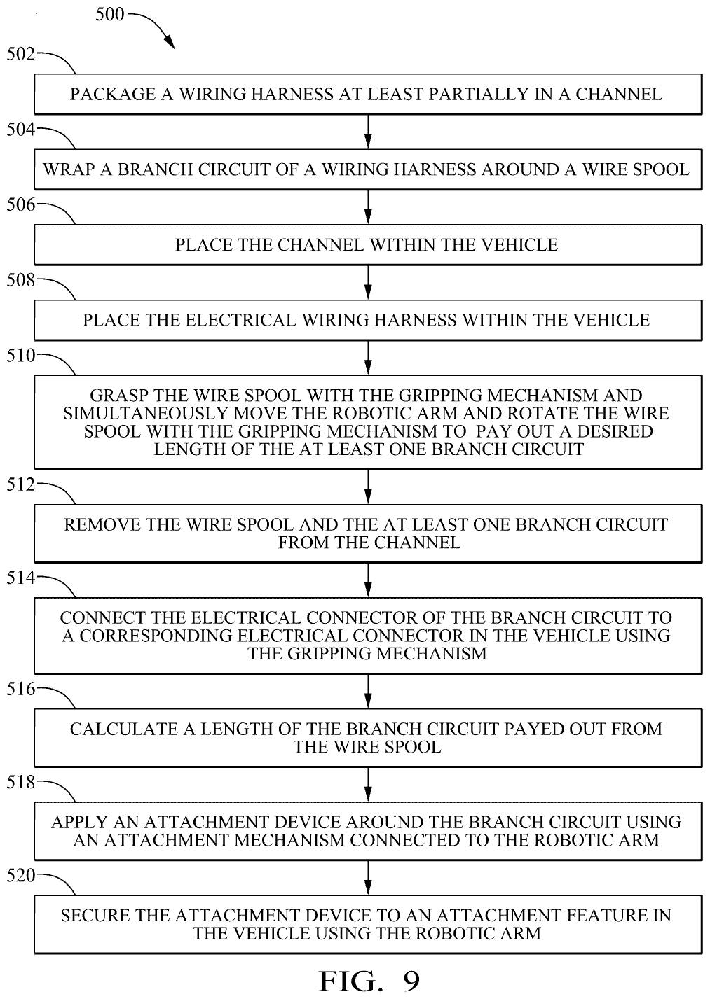

FIG. 9 shows a diagram of a method 500 of installing an electrical wiring harness in a vehicle, wherein the electrical wiring harness has at least one branch circuit terminated by an electrical connector includes the following steps:

STEP 502, PACKAGE THE WIRING HARNESS AT LEAST PARTIALLY IN A CHANNEL, includes packaging the wiring harness 100, at least partially, in a channel 102;

STEP 504, WRAP A BRANCH CIRCUIT OF A WIRING HARNESS AROUND A WIRE SPOOL, includes wrapping the at least one branch circuit 104 around a wire spool 106 that is configured to be picked up and manipulated by a robotic arm 112 having a gripping mechanism 110;

STEP 506, PLACE THE CHANNEL WITHIN THE VEHICLE, includes placing the electrical wiring harness 100 within the vehicle;

STEP 508, PLACE THE ELECTRICAL WIRING HARNESS WITHIN THE VEHICLE, includes placing the electrical wiring harness 100 within the vehicle;

STEP 510, GRASP THE WIRE SPOOL WITH THE GRIPPING MECHANISM AND SIMULTANEOUSLY MOVE THE ROBOTIC ARM AND ROTATE THE WIRE SPOOL WITH THE GRIPPING MECHANISM TO PAY OUT A DESIRED LENGTH OF THE AT LEAST ONE BRANCH CIRCUIT, includes grasping the wire spool 106 with the gripping mechanism 110 while simultaneously moving the robotic arm 112 and rotating the wire spool 106 with the gripping mechanism 110 to pay out a desired length of the at least one branch circuit 104;

STEP 512, REMOVE THE WIRE SPOOL AND THE AT LEAST ONE BRANCH CIRCUIT FROM THE CHANNEL, includes removing the wire spool 106 and the at least one branch circuit 104 from the channel 102;

STEP 514, CONNECT THE ELECTRICAL CONNECTOR OF THE BRANCH CIRCUIT TO A CORRESPONDING ELECTRICAL CONNECTOR IN THE VEHICLE USING THE GRIPPING MECHANISM, includes connecting the electrical connector 116 of the at least one branch circuit 104 to a corresponding electrical connector in the vehicle using the gripping mechanism 110;

STEP 516, CALCULATE A LENGTH OF THE BRANCH CIRCUIT PAYED OUT FROM THE WIRE SPOOL, includes calculating a length of the at least one branch circuit 104 payed out from the wire spool 106 based on a diameter of the wire spool 106, a number of rotations of the wire spool 106 by the gripping mechanism 110, and a diameter of the at least one branch circuit 104;

STEP 518, APPLY AN ATTACHMENT DEVICE AROUND THE BRANCH CIRCUIT USING AN ATTACHMENT MECHANISM CONNECTED TO THE ROBOTIC ARM, includes applying an attachment device 200, 300, 400 around the at least one branch circuit 104 using an attachment mechanism 118, 120 connected to the robotic arm 112; and

STEP 520, SECURE THE ATTACHMENT DEVICE TO AN ATTACHMENT FEATURE IN THE VEHICLE USING THE ROBOTIC ARM, includes securing the attachment device 200, 300, 400 to an attachment feature 202, 308, 408 in the vehicle using the robotic arm 112.

The attachment device may be a P-clamp 200 that is folded around the branch circuit 104 and the attachment feature may be a stud 202 projecting from a panel of the vehicle and inserted within a pair of aligned apertures 204 in the P-clamp 200. The stud 202 may be threaded and the P-clamp 200 may be secured to the stud 202 by a threaded nut (not shown). Alternatively, the stud 202 may be in a compressive fit with aligned apertures 204 in the P-clamp 200.

Alternatively, the attachment device may be a fir tree fastener 300 that is folded around the branch circuit 104. The fir tree fastener 300 may be inserted and secured within an aperture 308 defined in a panel 310 of the vehicle. The fir tree fastener 300 includes a pair of semi-cylindrical mounting studs 302 joined by a strap 304 therebetween. The pair of semi-cylindrical mounting studs 302 defines a plurality of protrusions 306 extending therefrom. The strap 304 is folded around the branch circuit 104 and the semi-cylindrical mounting studs 302 are brought together to form a cylindrical mounting stud defining the plurality of protrusions 306 extending therefrom. The plurality of protrusions 306 may be a plurality of semi-circular ribs. The plurality of semi-circular ribs are brought together to form a plurality of circular ribs extending from the cylindrical mounting stud.

In another alternative, the attachment device may be an annular disk 400 having a plurality of teeth 402 extending from an outer edge 404 of the annular disk 400 and a central aperture 406 in which the one branch circuit 104 is received. The annular disk 400 is configured to be received within a slit 410 in a panel 412 of the vehicle and is held in a compressive fit within the slit 410.

While the invention has been described with reference to an exemplary embodiment(s), it will be understood by those skilled in the art that various changes may be made, and equivalents may be substituted for elements thereof without departing from the scope of the invention. In addition, many modifications may be made to adapt a particular situation or material to the teachings of the invention without departing from the essential scope thereof. Therefore, it is intended that the invention is not limited to the disclosed embodiment(s), but that the invention will include all embodiments falling within the scope of the appended claims.

As used herein, ‘one or more’ includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing particular embodiments only and is not intended to be limiting. As used in the description of the various described embodiments and the appended claims, the singular forms “a”, “an”, and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Additionally, while terms of ordinance or orientation may be used herein these elements should not be limited by these terms. All terms of ordinance or orientation, unless stated otherwise, are used for purposes distinguishing one element from another, and do not denote any particular order, order of operations, direction or orientation unless stated otherwise.

1. A method of installing an electrical wiring harness in a vehicle, wherein the electrical wiring harness has at least one branch circuit terminated by an electrical connector, comprising:
wrapping the at least one branch circuit around a wire spool configured to be picked up and manipulated by a robotic arm having a gripping mechanism;
placing the electrical wiring harness within the vehicle; and
grasping the wire spool with the gripping mechanism while simultaneously moving the robotic arm and rotating the wire spool with the gripping mechanism to pay out a desired length of the at least one branch circuit.

2. The method in accordance with claim 1, further comprising:
connecting the electrical connector of the at least one branch circuit to a corresponding electrical connector in the vehicle using the gripping mechanism.

3. The method in accordance with claim 1, further comprising:
calculating a length of the at least one branch circuit payed out from the wire spool based on a diameter of the wire spool, a number of rotations of the wire spool by the gripping mechanism, and a diameter of the at least one branch circuit.

4. The method in accordance with claim 1, further comprising:
applying an attachment device around the at least one branch circuit using an attachment mechanism connected to the robotic arm; and
securing the attachment device to an attachment feature in the vehicle using the robotic arm.

5. The method in accordance with claim 4, wherein the attachment device is a P-clamp that is folded around the at least one branch circuit and wherein the attachment feature is a stud projecting from a panel of the vehicle and inserted within a pair of aligned apertures in the P-clamp.

6. The method in accordance with claim 5, wherein the stud is threaded and wherein the P-clamp is secured to the stud by a threaded nut.

7. The method in accordance with claim 5, wherein the stud is in a compressive fit with aligned apertures in the P-clamp.

8. The method in accordance with claim 4, wherein the attachment device is an annular disk having a plurality of teeth extending from an outer edge of the annular disk and a central aperture in which the at least one branch circuit is received and wherein the attachment feature is a slit in a panel of the vehicle and wherein the annular disk is in a compressive fit within the slit.

9. The method in accordance with claim 4, wherein the attachment device is a fir tree fastener that is folded around the at least one branch circuit and wherein the attachment feature is an aperture in a panel of the vehicle in which the fir tree fastener is inserted.

10. The method in accordance with claim 9, wherein the fir tree fastener includes a pair of semi-cylindrical mounting studs joined by a strap therebetween, wherein the pair of semi-cylindrical mounting studs defines a plurality of protrusions extending therefrom, wherein the strap is folded around the at least one branch circuit and the semi-cylindrical mounting studs are brought together to form a cylindrical mounting stud defining the plurality of protrusions extending therefrom.

11. The method in accordance with claim 10, wherein the plurality of protrusions are a plurality of semi-circular ribs and wherein the plurality of semi-circular ribs are brought together to form a plurality of circular ribs extending from the cylindrical mounting stud.

12. The method in accordance with claim 1, further comprising:
packaging the wiring harness at least partially in a channel; and
placing the channel and the wiring harness in the vehicle.

13. The method in accordance with claim 12, further comprising:
removing the wire spool and the at least one branch circuit from the channel.

14. An apparatus configured to install an electrical wiring harness having at least one branch circuit terminated by an electrical connector in a vehicle, the apparatus, comprising:
a robotic arm having a gripping mechanism configured to pick up and manipulate a wire spool having the at least one branch circuit wrapped around it, wherein the gripping mechanism is further configured to rotate the wire spool while the robotic arm is moving along a predetermined path to pay out a desired length of the at least one branch circuit and route the at least one branch circuit in the vehicle; and
an electronic controller configured to control actions of the gripping mechanism and the robotic arm.

15. The apparatus in accordance with claim 14, wherein the robotic arm and the gripping mechanism are further configured to connect the electrical connector of the at least one branch circuit to a corresponding electrical connector in the vehicle under direction of the electronic controller.

16. The apparatus in accordance with claim 14, wherein the electronic controller is configured to calculate a length of the at least one branch circuit payed out from the wire spool based on a diameter of the wire spool, a number of rotations of the wire spool by the gripping mechanism, and a diameter of the at least one branch circuit.

17. The apparatus in accordance with claim 16, further comprising an attachment mechanism connected to the robotic arm and configured to apply an attachment device around the at least one branch circuit at a predetermined point on the at least one branch circuit based on a calculated length of the at least one branch circuit.

18. An electrical wiring harness configured to use in a vehicle, comprising:
at least one branch circuit terminated by an electrical connector; and
an attachment device placed around the at least one branch circuit at a predetermined point, wherein the attachment device is selected from a list consisting of an annular disk having a plurality of teeth extending from an outer edge of the annular disk and a central aperture in which the at least one branch circuit is received, the annular disk configured to be received within a slit in a panel of the vehicle, a fir tree fastener that is folded around the at least one branch circuit and configured to be inserted in an aperture in a panel of the vehicle.

19. The electrical wiring harness in accordance with claim 18, wherein the fir tree fastener includes a pair of semi-cylindrical mounting studs joined by a strap therebetween, wherein the pair of semi-cylindrical mounting studs defines a plurality of protrusions extending therefrom, wherein the strap is folded around the at least one branch circuit and the semi-cylindrical mounting studs are brought together to form a cylindrical mounting stud defining the plurality of protrusions extending therefrom.

20. The electrical wiring harness in accordance with claim 19, wherein the plurality of protrusions is a plurality of semi-circular ribs and wherein the plurality of semi-circular ribs are brought together to form a plurality of circular ribs extending from the cylindrical mounting stud.
